(19) United States
(12) Patent Application Publication
(10) Pub. No.: US 2010/0062267 A1
(43) Pub. Date: Mar. 11, 2010

(54) LTCC LAYER STACK

(75) Inventor: Roman Karmazin, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/555,882

(22) Filed: Sep. 9, 2009

(30) Foreign Application Priority Data
Sep. 9, 2008 (DE) 10 2008 046 336.1

(51) Int. Cl. B32B 18/00; C04B 35/106

(52) U.S. Cl. 428/446; 428/702; 156/89.11

(57) ABSTRACT

An unsintered LTCC layer stack and a method of producing a sintered LTCC layer stack is described. In various embodiments, the unsintered LTCC layer stack includes a plurality of green ceramic layers which are stacked on top of one another and of which at least one first green layer contains zirconium oxide as the main constituent and an admixture of at least one sintering aid. In various embodiments, a process for producing a sintered LTCC layer stack includes producing an unsintered LTCC layer stack within an embodiment and sintering the unsintered LTCC layer stack.

### RELATED APPLICATIONS

The present application claims priority to German Patent Application No. 10 2008 046 336.1 filed Sep. 9, 2008, the disclosure of which is incorporated herein by reference in its entirety.

### FIELD

The present disclosure relates to an unsintered LTCC layer stack, an LTCC layer stack sintered therefrom, a ceramic electronic module comprising the sintered LTCC layer stack, a monolithic transformer comprising the sintered LTCC layer stack and a process for producing a sintered LTCC layer stack.

### BACKGROUND

A small amount of sintering aids is usually added to magnetic ceramic materials (ferrites) in order to make it possible to use these ferrites in the LTCC (Low Temperature Cofired Ceramics) method. However, commercially available base layers (also called base tapes) have a substantially higher content of sintering aids and their sintering behavior therefore differs from that of the LTCC ferrite materials. In addition, the coefficient of thermal expansion of the LTCC ferrite materials is high (11-12 (10⁻⁶ K⁻¹)) compared with that of the commercially available base layers (typically 5 to 6 (10⁻⁶ K⁻¹)). The differences in the sintering behavior and in thermal expansion result in the base layer and magnetic layer detaching from one another during the sintering or in the formation of stresses in the ferrite layers, which reduces the magnetic permeability of these layers. Therefore, the complete integration of magnetic ceramic materials into LTCC layer stacks requires a new base layer which ideally at least approximately satisfies the following boundary conditions:
a sintering temperature Ts≦1000° C., in particular Ts≦900° C.;
chemical compatibility with the ferrite materials;
a sintering behavior compatible with the ferrite materials (no layer detachment, only insignificant production of stresses in the ferrite layers);
a coefficient of thermal expansion of between 11 and 12 (10⁻⁶ K⁻¹); and
a permittivity ε≦20.

### SUMMARY

The present disclosure describes several embodiments of the present invention.

The present disclosure provides a ceramic LTCC layer stacks comprising magnetic ceramic layers, in which the magnetic layers become detached less readily than previously during the sintering and/or have a lower internal stress after the sintering.

This is achieved by means of an unsintered LTCC layer stack, an LTCC layer stack sintered therefrom, a ceramic electronic module, a monolithic transformer and a process for producing a sintered LTCC layer stack. Additional embodiments can be gathered, in particular, from the dependent claims.

The unsintered LTCC layer stack comprises a plurality of green (i.e. preshaped, for example pressed or cast but not yet sintered) ceramic layers which are stacked on top of one another and of which at least one first ceramic layer contains zirconium oxide (ZrO₂) as the main constituent and an admixture of at least one sintering aid. Tapes are frequently used as ceramic layers.

In its tetragonal form, for example, zirconium oxide has a coefficient of thermal expansion of between 11 and 12 (10⁻⁶ K⁻¹) and a permittivity ε of between 20 and 25. However, the sintering temperature of zirconium oxide is about 1500° C. to 1700° C. The admixture of the at least one sintering aid greatly reduces the sintering temperature to below 900° C., while at the same time retaining the permittivity ε value. A mixture of zirconium oxide and sintering aid(s) of this type is also compatible with typical ceramic ferrite materials both chemically and in terms of sintering behavior.

One embodiment of the present disclosure provides an unsintered LTCC layer stack in which the at least one first green ceramic layer contains an admixture of bismuth oxide as the sintering aid.

As an alternative or in addition, another embodiment of the present disclosure provides an unsintered LTCC layer stack in which the at least one first green ceramic layer contains an admixture of silicon oxide (SiO₂) as the sintering aid, in particular quartz-like silicon oxide.

However, the sintering aids are not restricted to those mentioned above. For example, it is also possible to use other oxide ceramics or glass frit.

Another embodiment of the present disclosure provides an unsintered LTCC layer stack in which at least one other green ceramic layer comprises a green ferrite ceramic layer. Preferred ferrite materials comprise MnZn, but it is also possible to use ferrites comprising NiZn or NiZnCu. In general, it is possible to use magnetic, in particular soft-magnetic, ceramics, in particular spinel ferrites.

In some embodiments of the present invention, it is preferred if the proportion of the sintering aid(s), in particular of bismuth oxide or of bismuth oxide and silicon oxide together, does not exceed a value of 20% by volume, especially 15% by volume, and in particular is in a region around 10% by volume.

In some embodiments, it is further preferred if the molar percentage of bismuth oxide is higher than that of silicon oxide.

Another embodiment of the present disclosure provides an unsintered LTCC layer stack in which the zirconium oxide is a tetragonal zirconium oxide (t-ZrO₂).

Another embodiment of the present disclosure provides an unsintered LTCC layer stack in which the zirconium oxide is cubic zirconium oxide (c-ZrO₂).

Another embodiment of the present disclosure provides an unsintered LTCC layer stack in which the zirconium oxide is a zirconium oxide stabilized or doped with 0 mol % to 15 mol % yttrium oxide (Y₂O₃), in particular with an yttrium oxide content of between 1 mol % and 10 mol %, especially between 3 mol % and 8 mol %. In some embodiments, particular preference is given to a tetragonal zirconium oxide stabilized with 3 mol % yttrium oxide (3YTZ), a 3YTZ having a smaller specific surface area (e.g. 7±2 m²/g instead of 16±3 m²/g) (3YTZ-S) or a cubic zirconium oxide stabilized with 8 mol % yttrium oxide (8YTZ), all of which are commercially available from TOSOH, Japan. In some embodiments, particular preference is given to a (cubic) c-ZrO₂ fully stabilized with 6 to 10 mol % yttrium oxide. However, stabilized zirconium oxide is not restricted to stabilization by yttrium oxide; in addition or as an alternative, the ZrO₂, in particular c-ZrO₂, may be stabilized using, for example, oxides with Ce3+, Ca2+, Mg2+, Sm3+ and many other oxides.

Another embodiment of the present disclosure provides an unsintered LTCC layer stack in which a first ceramic layer is a base layer (base tape) onto which at least one green magnetic ceramic layer is stacked. However, the LTCC layer stack is not restricted to this. In addition or as an alternative, it is therefore possible for one or more zirconium-oxide-based layers to be inserted between ferrite layers. The at least one first ceramic layer may therefore be an interlayer which is inserted between green magnetic ceramic layers; this creates a dielectric gap between the ferrite layers.

In some embodiments, the ferrite layers preferably have a thickness of between 0.1 mm and 3 mm; if a zirconium-oxide-based layer is inserted between these layers, each ferrite layer preferably has a thickness of between 1 and 2 mm. The zirconium-oxide-based layer preferably likewise has a thickness of between 0.1 and 3 mm; if a zirconium-oxide-based layer is inserted between ferrite layers, this thickness is preferably between 0.4 mm and 1.0 mm.

The sintered LTCC layer stack is produced by sintering an unsintered LTCC layer stack of this type. In this case, the sintering aids (Bi₂O₃, SiO₂ etc.) may be converted into a solid solution during the sintering with the (fully or partially) stabilized or unstabilized zirconium oxide.

Another embodiment of the present disclosure provides a sintered LTCC layer stack in which the sintering was carried out at a sintering temperature of 1000° C. or less, in particular at a sintering temperature of 900° C. or less.

The process for producing an LTCC layer stack comprises at least the following steps: (a) an unsintered LTCC layer stack as described above is produced; and (b) the unsintered LTCC layer stack is sintered, in particular at a sintering temperature of 900° C. or less.

### BRIEF DESCRIPTION OF THE DRAWINGS

The figures which follow describe the invention in more detail schematically, with reference to exemplary embodiments.

FIG. 1 is a sketch, in the form of a sectional illustration in a view from the side, of an LTCC layer stack having zirconium-oxide-based outer layers and intermediate ferrite ceramic layers; and

FIG. 2 shows a graph which plots a real component μ′ of a complex magnetic permeability against a measurement frequency in Hz for sintered LTCC layer stacks having the structure shown in FIG. 1 and comprising different materials of the zirconium-oxide-based layers.

### DETAILED DESCRIPTION

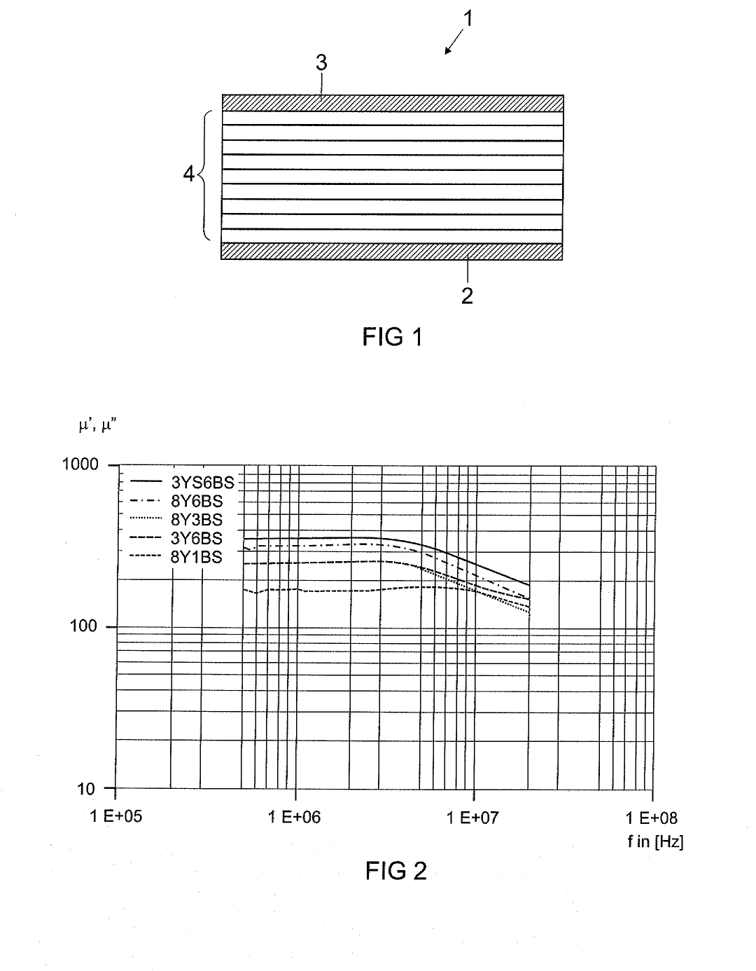

FIG. 1 shows an LTCC layer stack 1 which has a lower outer layer (base layer or base tape) 2 and an upper outer layer 3 which have an equal thickness and contain zirconium oxide as the main constituent and an admixture of a sintering aid in the form of a mixture of bismuth oxide and silicon oxide, wherein nine ceramic ferrite layers 4 are arranged between the outer layers 2, 3.

FIG. 2 shows a graph which plots a real component μ′ of a complex magnetic permeability against a measurement frequency in Hz for different sintered LTCC layer stacks. The measurements were carried out using the HP 4194A impedance measuring appliance from Hewlett-Packard, USA. The LTCC layer stacks each had a lower outer layer (base layer or base tape) and an upper outer layer which had been sintered with zirconium oxide as the main constituent, wherein nine ceramic ferrite layers are arranged between the outer layers. In detail, outer layers having the following material compositions were used:

a) 3YZT-S containing 10% by volume of an admixture of bismuth oxide and silicon oxide as sintering aid in a molar ratio Bi₂O₃:SiO₂ of 6:1 or the sintered product thereof [3YS6BS] having a maximum real component μ′ value of 375;

b) 8YZT containing 10% by volume of an admixture of bismuth oxide and silicon oxide in a molar ratio Bi₂O₃:SiO₂ of 6:1 or the sintered product thereof [8Y6BS] having a maximum real component μ′ value of 341;

c) 8YZT containing 10% by volume of an admixture of bismuth oxide and silicon oxide in a molar ratio Bi₂O₃:SiO₂ of 3:1 or the sintered product thereof [8Y3BS] having a maximum real component μ′ value of 266;

d) 3YZT containing 10% by volume of an admixture of bismuth oxide and silicon oxide in a molar ratio Bi₂O₃:SiO₂ of 6:1 or the sintered product thereof [3Y6BS] having a maximum real component μ′ value of 262; and

e) 8YZT containing 10% by volume of an admixture of bismuth oxide and silicon oxide in a molar ratio Bi₂O₃:SiO₂ of 1:1 or the sintered product thereof [8Y1BS] having a maximum real component μ′ value of 177.

In a low frequency range of between 500 KHz and about 3 MHz, all layer stacks have a substantially constant real component μ′ value. This value decreases toward higher frequencies. Only the layer stack containing 8Y1BS sees a later decrease, and this is also less pronounced than in the case of the other layer stacks.

The layer stack containing 3YS6BS in the outer layers has the greatest permeability real component μ′ value out of all the material compositions investigated, to be precise over the entire frequency range, followed by 8Y6BS and 8Y3BS. In the frequency range between 500 KHz and about 5 MHz, the layer stack containing 3Y6BS has approximately the same μ′ value as that containing 8Y3BS, but its μ′ value experiences a greater decrease than 8Y3BS at higher frequencies. The layer stack containing 8Y1BS in the outer layers has the lowest μ′ value at least up to 10 MHz. In particular, the layer stacks having an initial μ′ value of more than 300, i.e. whose containing 3YS6BS or 8Y6BS, are particularly suitable for use in ceramic electronic modules.

Further scanning electron microscopy investigations (not shown here) together with energy-dispersive X-ray spectroscopy investigations of the sintered LTCC layer stacks showed that there was good adhesion (no layer detachment) at the boundary between the outer layers and the adjacent ferrite layers, that no diffusion took place between the layers and that no chemical reaction took place between the materials of the layers. One preferred use is in lighting technology.

While the invention has been particularly shown and described with reference to specific embodiments, it should be understood by those skilled in the art that various changes in form and detail may be made therein without departing from the spirit and scope of the invention.

1. An unsintered LTCC layer stack comprising:
a plurality of green ceramic layers which are stacked on top of one another, wherein at least one first green ceramic layer comprises zirconium oxide as the main constituent and an admixture of at least one sintering aid.

2. The unsintered LTCC layer stack of claim 1, wherein the at least one first green ceramic layer comprises an admixture of bismuth oxide as the sintering aid.

3. The unsintered LTCC layer stack of claim 1 wherein the at least one first green ceramic layer comprises an admixture of silicon oxide as the sintering aid.

4. The unsintered LTCC layer stack of claim 1, wherein the zirconium oxide comprises tetragonal zirconium oxide.

5. The unsintered LTCC layer stack of claim 1, wherein the zirconium oxide comprises cubic zirconium oxide.

6. The unsintered LTCC layer stack of claim 1, wherein the zirconium oxide comprises a zirconium oxide stabilized with 0 mol % to 15 mol % yttrium oxide.

7. The unsintered LTCC layer stack of claim 6, wherein the zirconium oxide comprises a zirconium oxide stabilized with 1 mol % to 10 mol % yttrium oxide.

8. The unsintered LTCC layer stack of claim 6, wherein the zirconium oxide comprises a cubic zirconium oxide stabilized with 6 mol % to 10 mol % yttrium oxide.

9. The unsintered LTCC layer stack of claim 1, wherein:
the plurality of green ceramic layers comprises at least one green magnetic ceramic layer; and
a first ceramic layer comprises a base layer onto which the at least one green magnetic ceramic layer is stacked.

10. The unsintered LTCC layer stack of claim 1, wherein:
the plurality of green ceramic layers comprises at least two green magnetic ceramic layers; and
the at least one first ceramic layer comprises an interlayer inserted between the at least two green magnetic ceramic layers.

11. A process for producing an LTCC layer stack, said process comprising at least the following steps:
producing an unsintered LTCC layer stack comprising a plurality of green ceramic layers which are stacked on top of one another and of which at least one first green ceramic layer contains zirconium oxide as the main constituent and an admixture of at least one sintering aid; and
sintering the unsintered LTCC layer stack.

12. The process of claim 11, wherein sintering the unsintered LTCC layer stack comprises sintering the unsintered LTCC layer stack at a sintering temperature of 1000° C. or less.

13. The process of claim 11, wherein sintering the unsintered LTCC layer stack comprises sintering the unsintered LTCC layer stack at a sintering temperature of 900° C. or less.

14. The product of the process of claim 11.

15. The product of the process of claim 12.

16. The product of the process of claim 13.

17. A ceramic electronic module comprising the product of the process of claim 11.

18. A ceramic electronic module comprising the product of the process of claim 12.

19. A ceramic electronic module comprising the product of the process of claim 13.

20. A monolithic transformer, wherein a ceramic electronic module of the monolithic transformer comprises the product of the process of claim 11.

21. A monolithic transformer, wherein a ceramic electronic module of the monolithic transformer comprises the product of the process of claim 12.

22. A monolithic transformer, wherein a ceramic electronic module of the monolithic transformer comprises the product of the process of claim 13.
